(19) United States
(12) Patent Application Publication
(10) Pub. No.: US 2020/0409108 A1
(43) Pub. Date: Dec. 31, 2020

(54) OPTICAL LENS MODULE

(71) Applicant: AAC Optics Solutions Pte. Ltd., Singapore city (SG)

(72) Inventor: Jie Ma, Shenzhen (CN)

(21) Appl. No.: 16/914,370

(22) Filed: Jun. 28, 2020

(30) Foreign Application Priority Data
Jun. 28, 2019 (CN) PCT/CN2019/093912

(51) Int. Cl. G02B 13/00; G02B 7/02

(52) U.S. Cl. CPC G02B 13/0045; G02B 7/026; G02B 7/021

(57) ABSTRACT

Provided is an optical lens module including a lens barrel and a lens assembly. The lens barrel includes a top wall and a side wall. The top wall includes a connecting surface surrounding a light-through hole. Along a direction from an object side towards an image side, a distance between the connecting surface and an optical axis of the optical lens module gradually increases. The lens assembly includes a first lens including a fixing portion; and a second lens. The fixing portion includes a chamfered surface that fits the connecting surface. The lens of the optical lens module closer to the object side has a smaller outer diameter, thereby guaranteeing a surface shape of the lens. Moreover, the connecting surface fitting the chamfered surface can alleviate stray light, thereby improving an imaging effect of the optical lens module.

### TECHNICAL FIELD

The present invention relates to the technical field of optical imaging, and in particular, to an optical lens module.

### BACKGROUND

With development of camera technologies, optical lens modules have been widely used in various electronic products, such as mobile phones and tablets.

A traditional optical lens module mainly includes a lens barrel and a plurality of lenses installed into the lens barrel. Along a direction from an object side towards an image side, respective outer diameters of the plurality of lenses gradually decrease. Therefore, some lenses closer to the object side have larger outer diameters. However, due to limitation of optical parameters, each of these lenses shall have a relatively small core thickness. This increases a difficulty in shaping such a lens with a large outer diameter and a small core thickness, so that a surface shape of the lens cannot be guaranteed.

Therefore, it is necessary to provide an optical lens module to solve the technical problems described above.

### SUMMARY

The present invention provides an optical lens module, aiming to solve a problem of difficulty in shaping lenses of a traditional optical lens module.

Technical solutions of the present invention will be described in the following.

Embodiments of the present invention provide an optical lens module. The optical lens module includes a lens barrel and a lens assembly. The lens barrel includes a top wall and a side wall. The top wall and the side wall are connected to form a receiving cavity. The top wall includes a connecting surface surrounding a light-through hole in communication with the receiving cavity, and a distance between the connecting surface and an optical axis of the optical lens module gradually increases along a direction from an object side towards an image side. The lens assembly includes a plurality of lenses. The plurality of lenses is arranged sequentially along the direction from the object side towards the image side, and outer diameters of the plurality of lenses gradually increase along the direction from the object side towards the image side. The plurality of lenses includes a first lens penetrating through the light-through hole and a second lens received in the receiving cavity. A direction from the first lens towards the second lens is the same as the direction from the object side towards the image side. The first lens is a glass lens and includes an imaging portion and a fixing portion surrounding the imaging portion. The imaging portion penetrates through the light-through hole and protrudes from the top wall, and the fixing portion includes a chamfered surface that fits the connecting surface.

For the above-described optical lens module, the respective outer diameters of the plurality of lenses gradually increase along the direction from the object side towards the image side. Therefore, compared to a conventional optical lens module, for the optical lens module according to the present invention, the lens closer to the object side has a smaller outer diameter, thereby guaranteeing a surface shape of the lens. Moreover, the first lens of the plurality of lenses includes the chamfered surface, and the top wall of the lens barrel includes the connecting surface that fits the chamfered surface. In this way, the connecting surface fitting the chamfered surface can alleviate stray light, thereby improving an imaging effect of the optical lens module.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a structure of an optical lens module according to an embodiment of present invention;

FIG. 2 is a schematic diagram of a structure of a lens barrel of the optical lens module shown in FIG. 1;

FIG. 3 is a schematic diagram of a structure of a first lens of the optical lens module shown in FIG. 1;

FIG. 4 is a schematic diagram of a structure of a second lens of the optical lens module shown in FIG. 1; and

FIG. 5 is a schematic diagram of a structure of a conventional optical lens module.

### DESCRIPTION OF EMBODIMENTS

The present invention will be further described in the following with reference to the accompanying drawings and embodiments.

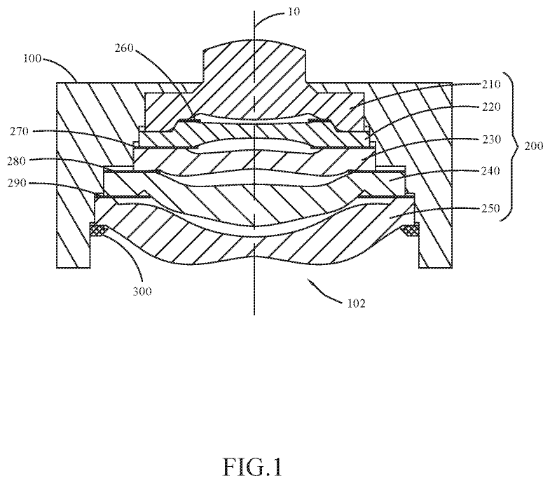

As shown in FIG. 1, an optical lens module according to an embodiment can be applied to an electronic product such as a mobile phone and a tablet. The optical lens module includes a lens barrel 100 and a lens assembly 200. The lens barrel 100 serves as a main installation structure for the lens module 200, and may be shaped as a cylinder or a square tube.

In combination with FIG. 1 and FIG. 2, the lens barrel 100 includes a top wall 110 and a side wall 120. The top wall 110 and the side wall 120 are connected together to form a receiving cavity 102. A part of the lens assembly 200 is installed into the receiving cavity 102. The top wall 110 is provided with a light-through hole 104 in communication with the receiving cavity 102. Light enters the receiving cavity 102 via the light-through hole 104.

The top wall 110 includes an outer surface 112, a connecting surface 114, and an inner surface 116. The outer surface 112 is opposite to the inner surface 116, and a direction from the outer surface 112 towards the inner surface 116 is the same as the direction from the object side towards the image side. In this embodiment, both the outer surface 112 and the inner surface 116 are perpendicular to an optical axis 10 of the optical lens module. It should be understood that, in other embodiments, the outer surface 112 and the inner surface 116 may also have other shapes. For example, each of the outer surface 112 and the inner surface 116 may also be a curved surface or an inclined surface that forms an acute angle with the optical axis 10.

Two ends of the connecting surface 114 are respectively connected to the outer surface 112 and the inner surface 116. The connecting surface 114 surrounds the light-through hole 104. In the direction from the object side towards the image side, a distance between the connecting surface 114 and the optical axis 10 gradually increases. Further, in this embodiment, a generatrix of the connecting surface 114 is a straight line. That is, in this embodiment, relative to the end of the connecting surface 114 connected to the outer surface 112, the end of the connecting surface 114 connected to the inner surface 116 is inclined along a direction facing away from the optical axis 10. In other embodiments, the generatrix of the connecting surface 114 may also be an arc.

A surface of the side wall 120 facing the receiving cavity 102 is a step surface 122 with multiple steps. Along the direction from the object side towards the image side, an inner diameter of the step surface 122 gradually increases.

The lens assembly 200 includes a plurality of lenses arranged sequentially along the direction from the object side towards the image side. Along the direction from the object side towards the image side, respective outer diameters of these lenses gradually increase, which is consistent with a changing trend of the inner diameter of the step surface 122 of the side wall 120. Moreover, the outer diameter of each of these lenses is adapted to the corresponding inner diameter of the step surface 122, so as to prevent the lens assembly 200 from a deviation with respect to a direction perpendicular to the optical axis 10.

The lens assembly 200 includes a first lens 210 and a second lens 220. A direction from the first lens 210 towards the second lens 220 is the same as the direction from the object side towards the image side. The first lens 210 penetrates through the light-through hole 104. The first lens 210 includes an imaging portion 212 and a fixing portion 214 surrounding the imaging portion 212. The imaging portion 212 penetrates through the light-through hole 104 and protrudes from the top wall 110. The fixing portion 214 is mainly located in the receiving cavity 102 and abuts against the top wall 110.

Further, with reference to FIG. 1 to FIG. 3, the first lens 210 includes a first curved surface 2122, a second curved surface 2124 connected to the first curved surface 2122, a chamfered surface 2142 connected to the second curved surface 2124, and a contact surface 2144 connected to the chamfered surface 2142. The imaging portion 212 includes the first curved surface 2122 and the second curved surface 2124. The second curved surface 2124 extends from the first curved surface 2122 while being bent, and the second curved surface 2124 is a cylindrical surface having an axis parallel with the optical axis 10. That is, a generatrix of the second surface 2124 is a straight line parallel to the optical axis 10.

The fixing portion 214 includes the chamfered surface 2142 and the contact surface 2144. The chamfered surface 2142 and the contact surface 2144 are connected together to form an object side surface of the fixing portion 214. The chamfered surface 2142 is a surface formed by performing a chamfer process on the second curved surface 2124 and the contact surface 2144. The chamfered surface 2142 fits the connecting surface 114. Correspondingly, when the chamfered surface 2142 is a surface formed by a beveling chamfer process, a generatrix of the connecting surface 114 is a straight line. When the chamfered surface 2142 is a surface formed by a rounding chamfer process, a generatrix of the connecting surface 114 is an arc. In this embodiment, the chamfered surface 2142 fitting the connecting surface 114 can reduce or even eliminate stray light formed at the chamfered surface 2142 of the first lens, thereby improving an imaging effect of the optical lens module.

The contact surface 2144 is located in the receiving cavity 102 and abuts against the inner surface 116. Like the inner surface 116, the contact surface 2144 is perpendicular to the optical axis 10. Therefore, the contact surface 2144 can completely fit the inner surface 116, thereby reducing or even eliminating stray light formed at the contact surface 2144 of the first lens 210. In this way, the imaging effect of the optical lens module can be improved.

The second lens 220 is located in the receiving cavity 102, and the outer diameter of the second lens 220 is greater than the outer diameter of the first lens 210.

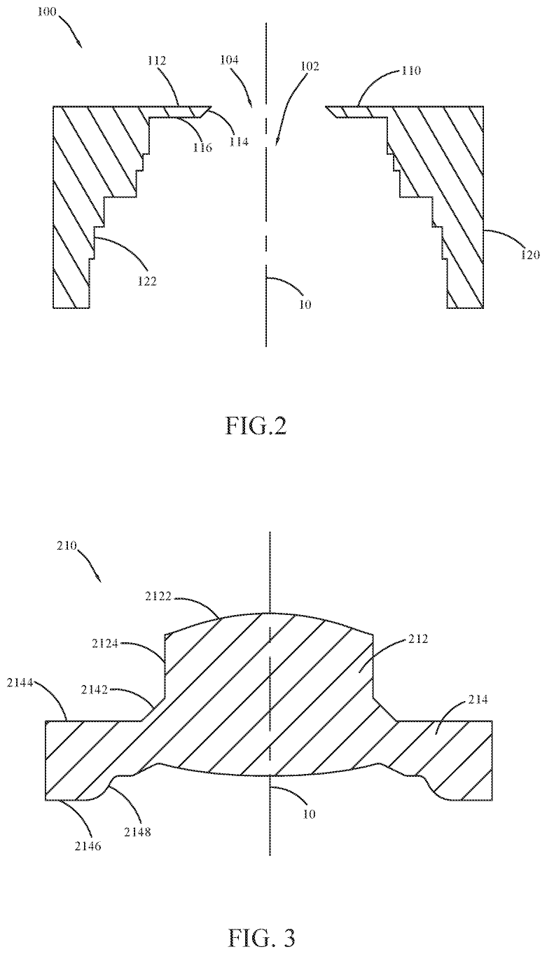

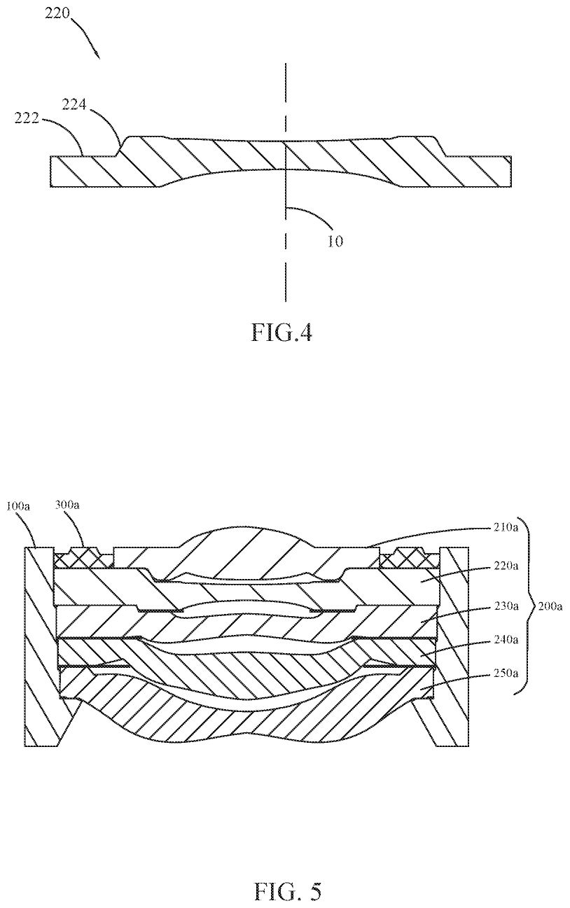

The first lens 210 engages with the second lens 220. As shown in FIG. 3 and FIG. 4, an image side surface of the fixing portion 214 includes a first horizontal surface 2146 and a first inclined surface 2148 extending towards the object side from the first horizontal surface 2146. The inclined surface 2148 is inclined towards the optical axis 10. An object side surface of the second lens 220 includes a second horizontal surface 222 and a second inclined surface 224 extending towards the object side from the second horizontal surface 222. The second inclined surface is inclined towards the optical axis 10. The first horizontal surface 2146 abuts against the second horizontal surface 222, and the first inclined surface 2148 abuts against the second inclined surface 224.

In this embodiment, the lens assembly 200 includes five lenses. In addition to the first lens 210 and the second lens 220, the lens assembly 200 includes a third lens 230, a fourth lens 240, and a fifth lens 250. The first lens 210, the second lens 220, the third lens 230, the fourth lens 240, and the fifth lens 250 are sequentially arranged along the direction from the object side towards the image side. That is, among these five lenses, the first lens 210 is closest to the object side, and the fifth lens 250 is closest to the image side. Moreover, the first lens 210 has the smallest outer diameter, and the fifth lens 250 has the largest outer diameter. It should be noted that the number of lenses included in the lens assembly 200 is not limited to the embodiment shown in FIG. 1, and the number of lenses may also be 2, 3, 4, or greater than 6.

The lens assembly 200 further includes a first light-shielding sheet 260, a second light-shielding sheet 270, a third light-shielding sheet 280, and a fourth light-shielding sheet 290. The first light-shielding sheet 260 is provided between the first lens 210 and the second lens 220, the second light-shielding sheet 270 is provided between the second lens 220 and the third lens 230, the third light-shielding sheet 280 is provided between the third lens 230 and the fourth lens 240, and the fourth light-shielding sheet 290 is provided between the fourth lens 240 and the fifth lens 250. Each light-shielding sheet is provided between two adjacent lenses and has a function of blocking stray light, so as to prevent stray light from entering an imaging region, which would otherwise affect an imaging quality thereof.

In this embodiment, each of the first light-shielding sheet 260, the second light-shielding sheet 270, the third light-shielding sheet 280, and the fourth light-shielding sheet 290 is made of a black plastic material by an injection molding process, so as to improve an accuracy of dimension. In this way, production errors will neither cause a decreased effect of blocking stray light nor shield too much effective imaging light, which would otherwise affect an imaging quality. In other embodiments, these light-shielding sheets may also be made by stamping a black thin film.

In combination with FIG. 1 and FIG. 2, the optical lens module further includes a press ring 300 located in the receiving cavity 102. The press ring 300 is connected to the side wall 120, so as to fix the plurality of lenses into the receiving cavity 102. In this embodiment, the press ring 300 is adhered to the side wall 120 by adhesive dispensing, and abuts against the image side surface of the fifth lens 250. It should be understood that, in other embodiments, the press ring 300 may also be connected to the side wall 120 by means of screw connection or snap-fit connection, which will not be limited herein.

When assembling the optical lens module in this embodiment, the first lens 210, the second lens 220, the third lens 230, the fourth lens 240, and the fifth lens 250 are sequentially assembled to the lens barrel 100 along the direction from the object side towards the image side. Then, the press ring 300 is connected to the lens barrel 100, so as to achieve fixing of the lens assembly 200.

When assembling a conventional optical lens module as shown in FIG. 5, the fifth lens 250a, the fourth lens 240a, the third lens 230a, the second lens 220a, and the first lens 210a are sequentially assembled to the lens barrel 100a along the direction from the image side towards the object side. Then, the press ring 300a is connected to the lens barrel 100a and the first lens 210a, so as to achieve fixing of the lens assembly 200a.

By comparing FIG. 1 with FIG. 5 and based on the shape of the lens barrel 100, the shape of the lens barrel 100a, and the changing trend of the outer diameter of each lens, it can be seen that compared to the traditional optical lens module, the lens of the optical lens module according to this embodiment closer to the object side has a smaller outer diameter. For example, the outer diameter of the second lens 220 is significantly smaller than the outer diameter of the second lens 220a. In this way, difficulty in shaping the lens closer to the object side can be decreased, thereby guaranteeing the surface shape of the lens closer to the object side.

In addition, in this embodiment, the press ring 300 is close to the image side of the optical lens module. The press ring 300 cooperates with the top wall 110 to fix the lens assembly 200 in an extending direction of the optical axis 10. When connecting the press ring 300 to the side wall 120, it is only needed to connect an outer side surface of the press ring 300 to the side wall 120. On the other hand, for the conventional optical lens module shown in FIG. 5, in which the press ring 300a is close to the object side of the optical lens module, it is needed to not only connect the outer side surface of the press ring 300a to the lens barrel 100a, but also connect the inner side of the press ring 300a to the first lens 210a, which leads to the more complicated installation process, thereby greatly decreasing an installation efficiency.

In addition, it should be noted that in this embodiment, the first lens 210 may be a glass lens, and each of the second lens 220, the third lens 230, the fourth lens 240, and the fifth lens 250 may be a plastic lens. However, in other embodiments, the first lens 210 may also be a plastic lens.

The above-described embodiments are merely preferred embodiments of the present invention. Various modifications can be made by those skilled in the art without departing from a concept of the present invention, and all these modifications shall fall into a protection scope of the present invention.

What is claimed is:

1. An optical lens module, comprising:
a lens barrel comprising a top wall and a side wall, wherein the top wall and the side wall are connected to form a receiving cavity, the top wall comprises a connecting surface surrounding a light-through hole in communication with the receiving cavity, and a distance between the connecting surface and an optical axis of the optical lens module gradually increases along a direction from an object side towards an image side; and
a lens assembly comprising a plurality of lenses, wherein the plurality of lenses is arranged sequentially along the direction from the object side towards the image side, and outer diameters of the plurality of lenses gradually increase along the direction from the object side towards the image side; the plurality of lenses comprises a first lens penetrating through the light-through hole and a second lens received in the receiving cavity, a direction from the first lens towards the second lens is the same as the direction from the object side towards the image side, the first lens is a glass lens and comprises an imaging portion and a fixing portion surrounding the imaging portion, the imaging portion penetrates through the light-through hole and protrudes from the top wall, and the fixing portion comprises a chamfered surface that fits the connecting surface.

2. The optical lens module as described in claim 1, wherein the imaging portion comprises a first curved surface and a second curved surface extending from the first curved surface while being bent and connected to the chamfered surface, and the second curved surface is a cylindrical surface having an axis parallel with the optical axis.

3. The optical lens module as described in claim 1, wherein a generatrix of the connecting surface is a straight line.

4. The optical lens module as described in claim 1, wherein the top wall further comprises an inner surface connected to the connecting surface, an object side surface of the fixing portion comprises a contact surface located in the receiving cavity and connected to the chamfered surface, the contact surface abuts against the inner surface, and both the contact surface and the inner surface are perpendicular to the optical axis.

5. The optical lens module as described in claim 4, wherein the top wall further comprises an outer surface connected to the connecting surface, the outer surface is opposite to the inner surface, and the outer surface is parallel to the inner surface.

6. The optical lens module as described in claim 1, wherein an image side surface of the fixing portion comprises a first horizontal surface and a first inclined surface extending towards the object side from the first horizontal surface, the first inclined surface is inclined towards the optical axis,
an object side surface of the second lens comprises a second horizontal surface and a second inclined surface extending towards the object side from the second horizontal surface, and the second inclined surface is inclined towards the optical axis, and
the first horizontal surface abuts against the second horizontal surface, and the first inclined surface abuts against the second inclined surface.

7. The optical lens module as described in claim 1, further comprising a press ring connected to the side wall, so as to fix the plurality of the lenses into the receiving cavity.

8. The optical lens as described in claim 1, wherein the second lens is a plastic lens.

9. The optical lens module as described in claim 1, wherein the lens assembly further comprises a third lens, a fourth lens, and a fifth lens, and the first lens, the second lens, and the third lens, the fourth lens, and the fifth lens are sequentially arranged along the direction from the object side towards the image side.

10. The optical lens module as described in claim 9, wherein the lens assembly further comprises a light-shielding sheet provided between two adjacent lenses of the plurality of lenses.
